(19) United States
(12) Patent Application Publication
(10) Pub. No.: US 2014/0244364 A1
(43) Pub. Date: Aug. 28, 2014

(54) BENCHMARKING SYSTEM USING BENCHMARKING SCENARIO TAG TEMPLATES

(71) Applicant: SAP AG, Walldorf (DE)

(72) Inventors: Harald Evers, Walldorf (DE); Steffen Springborn, Walldorf (DE); Gerald Krause, Walldorf (DE)

(73) Assignee: SAP AG, Walldorf (DE)

(21) Appl. No.: 13/781,696

(22) Filed: Feb. 28, 2013

(51) Int. Cl. G06Q 10/06

(52) U.S. Cl. CPC G06Q 10/06393
USPC 705/7.39

(57) ABSTRACT

In some implementations, a benchmarking system may be used to provide benchmarking data or reports. The benchmarking system may include benchmarking scenario tag templates that may include tags associated with defined data structures. In some instances, the data structures may be defined in a technology- or solution-independent manner. A business data provider may request a benchmarking tag template and associate the tags with the relevant elements of business data. The tagged elements of the business data may be extracted and transformed to be loaded into the benchmarking system. In some instances, the tagged elements of the business data may be transformed by anonymization or pseudonymization. The benchmarking system may use the tagged elements of the business data and other data to generate benchmarking data. The business data provider may opt in to a scenario to include the tagged elements of the business data into a benchmarking data database.

### BACKGROUND

Entities, such as businesses, may utilize backend systems to store data, such as business data. The business data may be used, in some instances, for analysis and/or reporting about the performance of the entity. Such analysis and/or reporting may be done by manually identifying the relevant elements of the business data and providing the relevant elements of the business data to a third party, such as a research firm, to be compared to one or more benchmark metrics or by internally comparing the relevant elements to one or more benchmark metrics.

### SUMMARY

One implementation relates to a method that may include receiving a benchmarking scenario tag template at a processing module. A tag of the benchmarking scenario tag template may be determined and one or more elements of the business data may be extracted based on the determine tag. The elements of the business data may be associated with the tag to generate tagged elements of the business data. A selection to pseudonymize or anonymize the tagged elements of business data may be received. The tagged elements of the business data may be transformed based on the selection.

In another implementation, a system may include a tangible computer-readable storage device having instructions and one or more data processors coupled to the tangible computer-readable storage device that are configured to execute the instructions to perform various operations. The operations may include transmitting a benchmarking scenario tag template having a tag associated with one or more data structures. An element of business data associated with the tag may be received. The element of the business data may include a pseudonymized or anonymized element of the business data. Benchmarking data may be generated based on the received pseudonymized or anonymized element of the business data and data from a database. The generated benchmarking data may be transmitted to a business data provider.

In yet a further implementation, a system may include a business data provider having a module. The module may be configured to: receive a first benchmarking scenario tag template,

identify a first set of elements of business data based on the first benchmarking scenario tag template, extract the identified first set of elements of business data, pseudonymize or anonymize an element of the extracted first set of elements of business data, and transmit the extracted first set of elements of business data to a remote system.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example computing device;

FIG. 2 is a block diagram of an example system having a client and a benchmarking system server;

FIG. 3 is a flow diagram of an example method for creating a benchmarking scenario tag template;

FIG. 4 is a flow diagram of an example method for searching benchmarking scenario tag templates;

FIG. 5 is an example process diagram for an example system having a business data provider and a benchmarking system server;

FIG. 6 is a block diagram of an example system having a client, a business data provider, and a benchmarking system server;

FIG. 7 is a block diagram of an example system having a business data provider having an ETL adapter; and

FIG. 8 is a block diagram of an example system having multiple entities with multiple business data providers and a benchmarking system server.

It will be recognized that some or all of the figures are schematic representations for purposes of illustration only. The figures are provided for the purpose of illustrating one or more implementations with the explicit understanding that they will not be used to limit the scope or the meaning of the claims.

### DETAILED DESCRIPTION

The following is merely provided for example purposes with the explicit understanding that the examples described herein will not be used to limit the scope or the meaning of the claims.

### I. Overview

Entities, such as businesses, utilize data in a variety of ways. For example, businesses may collect and integrate business data into business databases and/or data warehouses and report or otherwise utilize the data using business software, such as SAP®'s Travel OnDemand solution, SAP®'s Business Intelligence solutions, and/or other business solutions or software. In some instances, a business may analyze the business data in an isolated, enterprise-specific manner that utilizes the business's private data to generate reports. In some instances, the business may augment their own business data with business data from external sources (e.g., publically available data, credit card providers, online booking engines, vendors, travel management companies, purchasing card, data shared with other businesses, data from a third-party, etc.). The business data may be provided to a business data warehouse through extraction, transformation, and load (ETL) processes.

In some instances, entities, such as businesses, may desire benchmarking data and/or a benchmarking report to compare the business's performance relative to other entities, such as competitors, industry sectors, industries, markets, and/or other entities. The benchmarking data and/or report may include performance metrics or indicators based on business data. For example, the benchmarking data and/or report may include a balanced scorecard or process scorecard based on the performance metrics to provide performance feedback to the business or other entity. In other instances, the benchmarking data may be used to generate visual representations of the benchmarking metrics for the business data. Such benchmarking data and/or reports may be generated for various benchmarking scenarios. Examples of such benchmarking scenarios may include breakouts of travel spending by industry (e.g., automotive, aerospace & defense, chemicals, high tech, life sciences, mining, public sector, etc.), travel spending of a particular industry based on the expense types (e.g., per diem, fees, transportation, flight, hotel, rental car, mileage, other, etc.), geographic spending of an expense type for a specific industry (e.g., the top 3 hotel cost European countries for the automotive sector), overall travel spending by region, average expense type cost (e.g., average hotel cost per night), and/or other benchmarking scenarios. Accordingly, it may be useful to compare other business data with a business data provider's own business data. For example, a business entity may determine that it is overpaying for flight costs on a certain route based on the benchmarking data, including data from other entities, and the business entity may use the information to negotiate a better agreement with a flight provider. In other instances, such benchmarking data may be used by a travel manager to make better decisions regarding travel management (e.g., if the costs for travel to a certain region of the country are excessively high relative to the average cost of other businesses in the industry, the travel manager may scale back travel to that region and/or otherwise determine the cause of the high costs). In some implementations, a user interface may be provided such that a user may further examine or “drill down” through the various benchmarking scenarios when viewing the benchmarking data. While travel-related benchmarking is used in a number of the examples, a business or other entity may want to compare other types of business data or other non-business data for other benchmarking scenarios.

It may be useful to keep particular or specific data confidential so that competitors and/or other entities cannot take advantage of the information. For example, in the travel context, sensitive data may include supplier names, customer names, relationships, employee names, internal organizational structures and/or other data. Conventionally, the business may have a third-party, such as a research firm, manually collect their business data and generate benchmarking data to provide feedback to the business data provider about its performance while maintaining the business data confidential. In some instances, the third-party may collect the confidential information and compare the business's business data to business data from other businesses. However, the comparison may be less useful if the other businesses' data is outdated or the third-party does not have much data from other businesses for comparison. In addition, such benchmarking data may be less useful as different scenarios may not be available for comparing the business's data relative to other businesses. In some instances, the analysis and/or reporting may also occur at a low frequency. In other instances, individual software solutions may provide integrated benchmarking functionalities, though such functionalities may be limited to the particular software solution and the data associated therewith.

Referring generally to the figures, one embodiment that may achieve the aforementioned aspects includes a benchmarking system server that may interact with a business data provider system. The business data provider system may extract, transform, and transmit business data to the benchmarking system server for use in generating benchmarking data and/or a benchmarking report. To extract, transform, and transmit the business data, proxies may be used to receive and utilize benchmarking scenario tag templates to identify and extract business data from the business data provider system, in one implementation. In another implementation, an ETL adapter may be provided and used to identify and extract business data from the business data provider system. The proxies and/or ETL adapter may thus uniquely provide the business data provider with the capability to interact with the benchmarking system server by utilizing benchmarking scenario tag templates to identify business data based on tags, extract the tagged business data, transform the relevant portions of the business data, and transmit the business data to the benchmarking system server.

Such an embodiment may provide an online solution, such as a software-as-a-service (SaaS) benchmarking platform, to generate cross-entity and/or cross-provider benchmarking data on demand, with relatively high periodic frequency, and/or on a near real-time basis. The benchmarking platform may be useful to provide substantially up-to-date benchmarking data, provide a wide variety of benchmarking scenarios (i.e., different comparisons of business data), and/or provide a source for a plethora of benchmarking data from other businesses to provide useful benchmarking data. In addition, in some implementations the benchmarking platform may be able to receive business data from business data providers having different enterprise systems using ETL protocols. For example, the benchmarking platform (such as one provided on a benchmarking system server) may act as an ETL consumer and may be connected to multiple business data provider systems, acting as ETL providers, such that business data for tens, hundreds, thousands, and/or millions of businesses may be received and used for the benchmarking data. Each business data provider system may be part of an enterprise and each enterprise may include multiple business data provider systems, each of which may connect to the benchmarking system server.

Each business or data provider may identify, select, and transform their business data for the benchmarking system based on a benchmarking scenario tag template. The benchmarking system server may provide a form template to the business for population. In other implementations, the business may self-define the business scenario tag template. A benchmarking scenario tag template may be a template that identifies or describes the data structures of the business data needed for the benchmarking scenario associated with the benchmarking scenario tag template. The benchmarking scenario tag template may include the applicable tags (i.e., attributes) that a business or other data provider may use to identify their business data for that scenario. In some instances, the tags of the benchmarking scenario tag template may include both mandatory tags and optional tags. In addition, the benchmarking scenario tag template may identify whether anonymization and/or pseudonymization is applicable for the business data of each tag or attribute.

Therefore, utilizing the benchmarking scenario tag template, the business data provider may determine the elements of their business data to be tagged and whether the tagged elements are to be pseudonymized or anonymized. Once the elements of the business data have been tagged and pseudonymized or anonymized, the business data provider system may transmit the transformed elements of their business data to the benchmarking system server.

The benchmarking system server may receive the transformed elements from a business data provider, store the received elements in a database, and generate benchmarking data, such as result data, a report, and/or other benchmarking data. In one implementation, a graphical user interface may provide bar graphs or other representative figures depicting the generated benchmarking data. The benchmarking data may be based on the transformed elements received from multiple business data providers and/or from other sources.

A business data provider may access and/or otherwise receive the benchmarking data from the benchmarking system server. For example, the benchmarking system server may generate anonymized benchmarking data or pseudonymized benchmarking data based on the transformed elements received from the business data provider.

In one example, a business data provider may send business data, such as travel costs, etc., in a pseudonymized manner (i.e., having an artificial identifier for that business data provider or other business data elements (e.g., suppliers, vendors, etc.) associated with the tagged elements of the business data such that the business data provider may not be readily identifiable based on the artificial identifier. In such an implementation, the business data provider may utilize the pseudonymized benchmarking data to extract data associated with the artificial identifier to provide the benchmarking data as well as a comparison or other indicator of the business's performance relative to the benchmarking data (e.g., by outputting a graph representative of an average benchmarking value and a graph representative of the business's business data relative to the benchmarking value). Thus, the pseudonymized benchmarking data can include a highlight or other indicator to identify the business's ranking or performance relative to the benchmarking data. In some examples, the artificial identifier may be detected within the received benchmarking data. The business data provider may generate a graph, chart, diagram, or other visual representation that highlights or otherwise identifies its pseudonymized business data of the business data provider relative to the generated cross-entity benchmarking data. In other instances, textual benchmarking data may be provided with a comparison, ranking, or other indicator to compare the business's pseudonymized business data with the generated cross-entity benchmarking data. In some instances, the actual values may be provided (e.g., specific dollar amounts for hotel room costs, etc.) or relative values may be utilized (e.g., an average value of 100 may be used and the value associated with the business data provider may be provided relative to the average value of 100, such as 115 if the business's value is higher than average or 85 if the business's value is lower than average).

In another example, anonymized elements of the business's business data may be used to generate the benchmarking data. For example, a business data provider may send business data, such as travel costs, etc., in an anonymized manner. The benchmarking system server may utilize the anonymized elements of business data to generate anonymized benchmark data (e.g., benchmarking metrics without identifiable or detectible data associated with the business data provider). Such anonymized benchmarking data or reports incorporating the anonymized elements of business data may simply provide aggregate performance metrics. In some instances, the business data provider may separately access its business data from a local source, such as a database, for comparison to the anonymized benchmarking data. In some implementations, the business or data provider may opt-in and/or agree to an ETL process for the benchmarking scenario. An example of systems and methods for implementing the above benchmarking systems and the benchmarking scenario tag templates will now be described in greater detail.

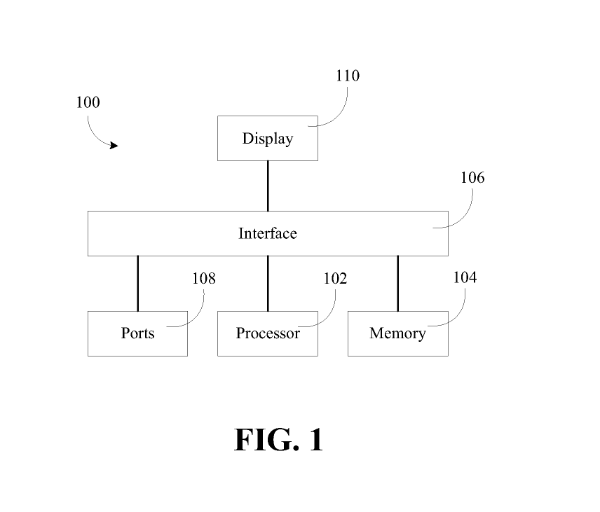

Referring to FIG. 1, a computing device 100 or set of computing devices 100 may be used to implement the systems and methods in accordance with the implementations described herein, as either a client or as a server or plurality of servers. The computing device 100 may include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

The computing device 100 includes a processor 102, memory 104, an interface 106 and ports 108. Each of the components 102, 104, 106, and 108, are interconnected using various buses, and may be mounted on a common motherboard or in other manners as appropriate. The processor 102 can process instructions for execution within the computing device 100, including instructions stored in the memory 104 to display graphical information for a graphical user interface (GUI) on an external input/output device, such as a display 110 coupled to the interface 106.

In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, a multi-processor system, etc.). The ports 108, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 102 may provide, for example, for coordination of the other components of the device 100, such as control of user interfaces, applications run by the device 100, and wireless communication by the device 100. The processor 102 may communicate with a user via the interface 106 (e.g., control, display, external, etc.), coupled to a display 110. The display 110 may be, for example, a TFT (Thin-Film-Transistor Liquid Crystal Display) display, an OLED (Organic Light Emitting Diode) display, other flexible display, etc. The interface 106 may include circuitry for driving the display 110 to provide graphical, textual, and other information to a user. The interface 106 may also receive commands (e.g., voice-activated, text, etc.), from a user and convert them to provide to the processor 102.

In addition, the interface 106 may be provided to communicate with the processor 102 and enable near area communication of the device 100 with other devices. The interface 106 may provide, for example, for wired communication over a network, such as the internet or other network. In some implementations, multiple interfaces may be used. The computing device 100 may also communicate wirelessly through the interface 106, which may include digital signal processing circuitry where necessary. The interface 106 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. A Global Positioning System (GPS) receiver module may provide additional navigation- and location-related wireless data to the device 100, which may be used as appropriate by applications running on the device 100. The device 100 may also be provided with a storage device to provide additional storage, e.g., solid-state flash media. Each of the components may be interconnected using various buses. Several of the components may be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 includes both volatile memory units and non-volatile memory units. The memory 104 may also be another form of computer-readable medium, such as a magnetic or optical disk. The memory 104 may be capable of providing mass storage for the computing device 100. In one implementation, the memory 104 may be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product may be tangibly embodied in an information carrier. The computer program product may also contain instructions that, when executed, perform one or more methods, such as those described below. The information carrier is a computer or machine-readable medium, such as the memory 104, memory on processor 102, etc. Expansion memory may be provided and connected to the device 100 through the interface 106. The processor 102 and the memory 104 or other memory (e.g., inside the processor) may form a processing circuit or processing module for completing the activities described herein.

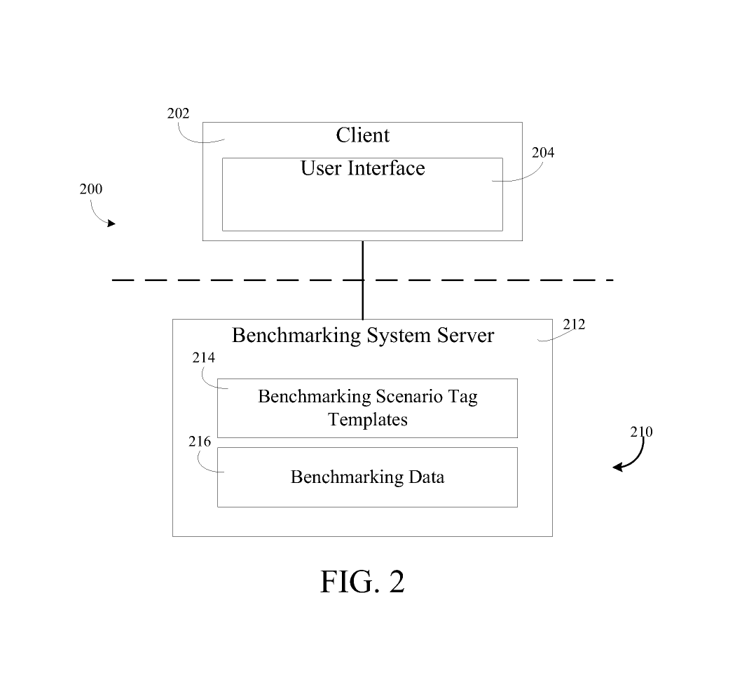

FIG. 2 depicts an example system 200 that may be used by a user. The system may include a client 202 and a backend system 210 having a benchmarking system server 212 with benchmarking scenario tag templates 214 and benchmarking data 216. The client 202 may be a computing device, such as the computing device 100 of FIG. 1. In some instances, the client 202 may include a laptop, desktop, mobile device, tablet, and/or other computing device that may be used by a user. The client 202 may include a user interface 204 for accessing and/or otherwise interacting with the backend system 210 via the client 202. The user interface 204 may be provided by a local application, a web application, and/or any other method for allowing a user of the client 202 to provide input and receive output from the backend system 210. In some instances, the user interface 204 may be provided via HTML5 or JavaScript® on a web browser of the client 202. In other instances, the user interface 204 may include an application running on the client 202 that is configured to access the benchmarking system server 212. By way of example, an example user interface may be provided by SAP®'s Business Objects BI OnDemand solution. Of course other ways of providing a user interface 204 to interact with the benchmarking system server 212 may be implemented as well.

The backend system 210 of the present example includes a benchmarking system server 212 having benchmarking scenario tag templates 214 for implementing the tagging of elements of business data described herein. The benchmarking scenario tag templates 214 may be received from the benchmarking system server 212. The benchmarking scenario tag templates 214 are stored in, for example, a database. A benchmarking scenario tag template 214 may be associated with a specific benchmarking scenario and/or hierarchy of benchmarking scenarios and may include one or more tags and may define one or more data structures with which each tag may be associated. In some instances, the defined one or more data structures may be independent of a specific technology or business solution (e.g., the data structures may refer to a category and type of data, such as a category of hotel room cost per night with a data type of a monetary value). The benchmarking scenario tag templates 214 may also include additional annotations to assist the user in associating the relevant elements of the business data with the tags of the benchmarking scenario tag template. In one example, a benchmarking scenario tag template 214 for a travel expense benchmarking scenario may include tags for data structures associated with travel types or modes (e.g., flight, car, train, etc), vendors (e.g., airline, hotel operator, rental agency, etc.), cost, duration, etc. Thus, a user may identify and associate each tag with the relevant elements of the business data for the identified data structures, as will be described below. A tag may refer to metadata that may be associated with business data and/or metadata of a business data provider such that the tagged business data and/or metadata may be identified and utilized by the benchmarking system server 212. Thus, when the tagged elements of the business data are received by the benchmarking system server 212, the benchmarking system server 212 may utilize the associated tags to organize and/or analyze the same tagged elements of the business data. Thus, the benchmarking system server 212 may compare the same elements of business data for each business data provider based on the associated tags to result in a suitable comparison to provide meaningful data. In addition, in some implementations, the benchmarking system server 212 may add the tagged elements of business data to the benchmarking data of a certain scenario. It should be understood that the benchmarking scenario tag template 214 may not be a file that is populated (manually or automatically) by the business data provider.

In some implementations, the benchmarking scenario tag templates 214 may include data indicating which tags are mandatory and which tags are optional for the associated benchmarking scenario. In some instances, the benchmarking scenario tag templates 214 may also include data indicating what business data may be anonymized and/or pseudonymized. For example, a benchmarking scenario may not utilize and/or accept pseudonymized business data for certain benchmarking scenarios and/or for certain benchmarking metrics. Accordingly, the tagged elements of the business data may only be anonymized.

The benchmarking system server 212 further includes benchmarking data 216 for generating the benchmarking data and/or report. The benchmarking data 216 may be stored in, for example, a database of the benchmarking system server 212. It should be understood that both the benchmarking scenario tag template 214 and the benchmarking data 216 may be stored in a persistent manner in many ways including, for example, a file system on the server 212 or a database on the benchmarking system server 212.

The benchmarking system server 212 may be a computing device, such as computing device 100 of FIG. 1, and/or the benchmarking system server 212 may be configured otherwise. In some instances, the benchmarking system server 212 may be or include several computing devices, such as a cloud server cluster. The benchmarking system server 212 may be configured to interface with the client 202 and receive and/or transmit input and/or output to the user interface 204 of the client 202.

The user interface 204 may be used to interact with the benchmarking scenario tag templates 214 and/or the benchmarking data 216 received from business data providers. In some instances, several user interfaces and/or a user interface having several permission levels may be provided. For example, a configuration user interface 204 may be provided for defining benchmarking scenario tag templates 214. The configuration user interface 204 may be used to add tags to a benchmarking scenario tag template 214, define the business data structures for each tag, define the benchmarking data and/or report that is output based on the tagged business data, associate portions of the benchmarking data 216 that may be used in generating the benchmarking data and/or report, indicate which tags are mandatory and/or optional, indicate whether anonymization or pseudonymization is applicable for the tagged elements of the business data, define the type of visualization used for the report and/or result, and/or otherwise configure the benchmarking scenario tag template 214.

In other instances, the user interface 204 may be used by a user associated with a business data provider or other entity to select and/or retrieve a benchmarking scenario tag template 214 and/or request a cross-entity and/or cross-provider benchmarking report, where the cross-entity and/or cross-provider benchmarking report is generated based on business data received from multiple business data providers across multiple entities. In still further instances, the user interface 204 may be used by a business data provider to provide tagged elements of business data to be included with the benchmarking data 216 of the benchmarking system server 212. In some instances, protocols and/or proxies may be utilized to provide interfaces between the various components of the benchmarking system server 212 and a system of the business data provider.

In some instances, an ETL adapter may be utilized by the client 202, such as a business data provider, to interface with the benchmarking system server 212. The ETL adapter may be configured to periodically or on-demand extract and tag business data from the client to be sent to the benchmarking system server 212. The ETL adapter may be used by the user associated with a business data provider or other entity to select and/or retrieve a benchmarking scenario tag template 214 and/or request a cross-entity and/or cross-provider benchmarking report, where the cross-entity and/or cross-provider benchmarking report is generated based on business data received from multiple business data providers across multiple entities. The ETL adapter may be used by a business data provider to extract and tag elements of business data to be extracted and included with the benchmarking data 216 of the benchmarking system server 212. In some instances, protocols and/or proxies may be utilized to provide interfaces between the various components of the benchmarking system server 212 and the ETL adapter.

### II. Example Benchmarking System and Benchmarking Scenario Tag Templates

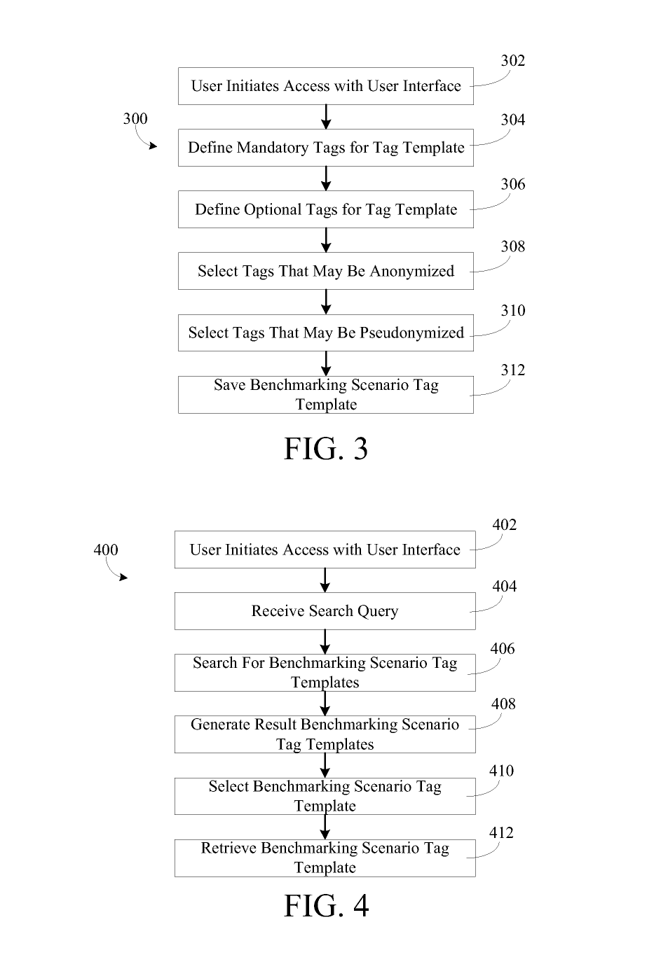

FIG. 3 depicts an example flow diagram for a method 300 for configuring benchmarking scenario tag templates 214 by using a user interface, such as the user interface 204 of FIG. 2. A user may initiate access to the benchmarking system server 212 using a user interface 204 (block 302). In one implementation, the user may login to a web application using a web browser. In another implementation, the user may launch a native application on the client. Upon launching the application, the user may authenticate with the benchmarking system server 212. Once the user is authenticated, the user may be presented with a user interface that allows interaction with the benchmarking system server 212. The level of interaction permitted may depend on the credentials of the logged in user.

For example, the user may create a new benchmarking scenario tag template 214 by, for example, clicking on a button or following a link. Using the user interface 204, the user may create and/or associate mandatory tags for the benchmarking scenario tag template 214 (block 304). In one implementation, the user may click on a button indicating that a new mandatory tag may be created. In response, the user interface 204 may display a mandatory tag form or other feature for defining the new mandatory tag. The user may populate the form with information related to the tag. For example, the user may provide a name for the tag, define the business data structures associated with the tag, provide a description of the tag, and/or otherwise define the tag. Once the form has been populated, the user may click on a button to save the new tag. The tags may be stored in a database of the benchmarking system server 212. In some instances, a user can associate a pre-created tag with the benchmarking scenario tag template 214. Accordingly, existing tags can be selected for the benchmarking scenario tag template 214. The user may create and/or associate several mandatory tags using substantially the same method.

Using the user interface 204, the user may create optional tags for the benchmarking scenario tag template 214 (block 306). In one implementation, the user may click on a button indicating that a new optional tag should be created. In response, the user interface 204 may display an optional tag form or other feature for defining the new optional tag. The user may populate the form with information related to the tag. For example, the user may provide a name for the tag, define the business data structures associated with the tag, provide a description of the tag, and/or otherwise define the tag. Once the form has been populated, the user may click on a button to save the new tag. The tags may be stored in a database of the benchmarking system server 212. In some instances, a user can associate a pre-created tag with the benchmarking scenario tag template 214. Accordingly, existing tags can be selected for the benchmarking scenario tag template 214. The user may create several optional tags using substantially the same method.

Using the user interface 204, the user may select the tags for which business data may be anonymized (block 308). In one implementation, the user may be presented with a list of the mandatory and/or optional tags created and/or associated with the benchmarking scenario tag template 214. The user may select one or more tags, such as via a checkbox and/or other selection feature, which may cause each of the selected tags to be highlighted or otherwise indicated in the user interface 204. Once the user has selected all desired tags, the user may click on a button and/or other selection feature to indicate that the business data associated with the selected tags may be anonymized. The user may additionally select a different subset of tags and indicate that the business data associated with the second subset of tags may also be anonymized. In another implementation, the user may indicate that the business data associated with a tag may be anonymized when creating the new tag (block 304, 306).

Using the user interface 204, the user may select the tags for which business data may be pseudonymized (block 310). In one implementation, the user may be presented with a list of the mandatory and/or optional tags created and/or associated with the benchmarking scenario tag template 214. The user may select one or more tags, such as via a checkbox and/or other selection feature, which may cause each of the selected tags to be highlighted or otherwise indicated in the user interface 204. Once the user has selected all desired tags, the user may click on a button or other selection feature to indicate that the business data associated with the selected tags may be pseudonymized. The user may additionally select a different subset of tags and indicate that the business data associated with the second subset of tags may also be pseudonymized. In another implementation, the user may indicate that the business data associated with a tag may be pseudonymized when creating the new tag (block 304, 306).

In some implementations, the business data providers may opt-in for one or more of the benchmarking scenario tag templates 214 to permit the benchmarking system server 212 to selectively extract, transform, and load the tagged elements of business data to be extracted and included in the benchmarking data 216 of the benchmarking system server 212. In some instances, the utilization of the benchmark scenario tag template 214 may require or incentivize opting-in (e.g., by providing the benchmarking data for free or at a discount if the business data provider opts-in to provide their tagged elements of business data for inclusion in the benchmarking data 216).

The user may save the benchmarking scenario tag template 214 in a database or other data storage device associated with the benchmarking system server 212 of FIG. 2 (block 312). In one implementation, the user may, for example, click on a button to save the benchmarking scenario tag template 214. The benchmarking scenario tag template 214 may be stored in a database of the benchmarking system server 212. Upon saving the benchmarking scenario tag template 214, the user interface 204 may present the user with a confirmation that the benchmarking scenario tag template 214 has been saved. Benchmarking scenario tag templates may be created and distributed by benchmarking administrators or entities which manage the benchmarking system server 212. Saved benchmarking scenario tag templates 214 may be distributed to others via the adapters or proxies described herein.

FIG. 4 depicts an example flow diagram for a method 400 for retrieving benchmarking scenario tag templates 214 by using a user interface, such as the user interface 204 of FIG. 2. A user may initiate access to the benchmarking system server 212 using the user interface 204 (block 402). In one implementation, the user initiates access to the benchmarking system server 212 in substantially the same way as in block 302 for FIG. 3, referenced above.

Using the user interface 204, the user may enter a search query string to search for benchmarking scenario tag templates 214. In one implementation, the user interface 204 may present the user with a text entry field and a button, such as a “search” button. The user may enter a search query string into the text field and click the button to indicate that the benchmarking scenario tag templates 214 stored on the benchmarking system server 212 be searched based on the search query string. The search query string may be received by the benchmarking system server 212 (block 404).

The benchmarking system server 212 may search the benchmarking scenario tag templates 214 for matching results for the search query string (block 406). In one implementation, the benchmarking system server 212 may construct an SQL query to search the database on which the benchmarking scenario tag templates 214 are stored. Of course, other methods of searching for and/or retrieving benchmarking scenario tag templates 214 may be used.

Upon completion of the search by the benchmarking system server 212, the results may be presented to the user (block 408). In one example implementation, the results may be presented as a list of benchmarking scenario tag template 214 names, a description of the benchmarking scenario tag templates 214, and/or other information associated with the benchmarking scenario tag templates 214. In another example implementation, the results may be presented as a grid of icons, wherein each icon represents a unique benchmarking scenario tag template 214.

Using the user interface 204, the user may select one or more benchmarking scenario tag templates 214 from a result set of benchmarking scenario tag templates 214 displayed on the user interface 204 (block 410). In one example implementation, the user may select benchmarking scenario tag templates 214 from a result set by toggling a checkbox next to the desired benchmarking scenario tag template in the result set. In another example implementation, the user may drag and drop a desired benchmarking scenario tag templates 214 on to a designated area of the user interface 204. In still another example implementation, the user may simply click a link or other feature to select a benchmarking scenario tag template 214.

The selected benchmarking scenario tag templates may be retrieved, (block 412) such as from a database, data warehouse, and/or other data storage device of the benchmarking system server 212, and, in some implementations, the client 202 may store the benchmarking scenario tag templates 214 locally such that the benchmarking scenario tag templates 214 may remain accessible even if the client 202 is no longer connected to the benchmarking system server 212. In one example implementation, the user, using the user interface 204, may indicate that the selected benchmarking scenario tag templates 214 are to be copied to a storage device associated with the client 202. For example, the user may click on a button indicating that the selected benchmarking scenario tag templates 214 should be downloaded or otherwise retrieved from the benchmarking system server 212 and stored in a storage device associated with the client 202. Using the user interface 204, the user may select a destination on the storage device associated with the client 202, such as a folder. As will be described in greater detail below, the benchmarking scenario tag templates 214 may be used to identify and associate one or more elements of the business data of the business data provider with one or more tags of the benchmarking scenario tag template 214. The tagged elements of business data may then be transmitted to the benchmarking system server 214 to generate benchmarking data and/or a benchmarking report for the associated benchmarking scenario.

In some implementations, the benchmarking scenario tag templates 214 may simply be presented in a list or otherwise such that a user may simply select one or more desired benchmarking scenario tag templates 214 without performing a search.

While the foregoing methods 300, 400 describe the creation and/or retrieval of benchmarking scenario tag templates 214 from an example benchmarking system server 212, in some instances a business data provider may want to utilize a benchmarking system server to generate benchmarking data and/or a benchmarking report and/or to provide tagged business data to the benchmarking system server. For example, a balanced scorecard (e.g., a report that may be used to keep track of activities or measures of employees compared target values) and/or a process scorecard may be generated using the benchmarking data and/or as part of the benchmarking report. In other implementations, the benchmarking data and/or report may include a graphical representation to visually represent the benchmarking metrics and/or performance of the business data provider relative to the benchmarking metrics (e.g., bar graphs, pie charts, etc.). To generate such benchmarking data and/or reports, a business data provider may transmit business data to the benchmarking system server, though the business data provider may simply provide business data to the benchmarking system server independent of such benchmarking data and/or reports. For example, the business data provider may provide business data to the benchmarking system server for monetization purposes and/or otherwise. In other instances, such benchmarking data and/or reports may be requested and/or received independent of transmitting business data to the benchmarking system server.

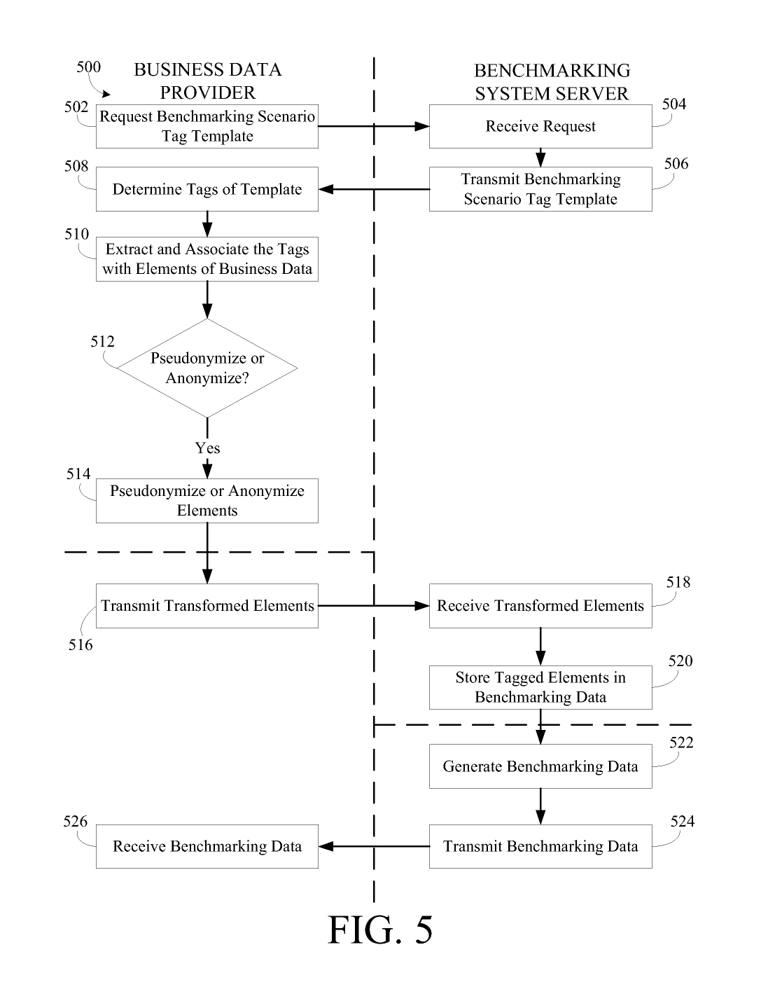

A concern that an entity may have when exposing business data to the benchmarking system server is maintaining the confidentiality of business data being transmitted to the benchmarking system server. FIG. 5 depicts an example process 500 for a business data provider to transmit tagged elements of business data to the benchmarking system server in an anonymized and/or pseudonymized manner and/or receive benchmarking data and/or a benchmarking report based on a selected benchmarking scenario tag template. In some instances, it may be useful to provide the benchmarking system server as a software as a service (SaaS) solution that may access the business data of various business data providers based on ETL protocols and/or otherwise.

A business data provider may request a benchmarking scenario tag template from the benchmarking system server (block 502). For instance, the business data provider may search for a benchmarking scenario tag template in accordance with method 400 described herein and/or the business data provider may request a benchmarking scenario via other methods, such as selecting a benchmarking scenario tag template from a list and/or otherwise. The request for a benchmarking scenario tag template may be transmitted to the benchmarking system server, such as benchmarking system server 212 of FIG. 2, via a network, such as the internet or other network. In some implementations, additional data may be transmitted to the benchmarking system server with the request for a benchmarking scenario tag template. For instance, such additional data may include login credentials, subscriber information, data regarding changes to the business data provider's business data, and/or etc. In some instances, several benchmarking scenario tag templates may be requested.

The benchmarking system server may receive the request (block 504) and retrieve the requested benchmarking scenario tag template from a database and/or other storage device having benchmarking scenario tag templates. The benchmarking system server may transmit the requested benchmarking scenario tag template to the business data provider (block 506).

The business data provider may receive the benchmarking scenario tag template and determine the tags for the benchmarking scenario tag template (block 508). For example, the tags of the benchmarking scenario tag template may be parsed and the associated data structures for the tags may be identified. In some implementations, a user interface may be provided on a display associated with the business data provider, such as a display of a client connected to the business data provider and/or otherwise, to display information about the benchmarking scenario tag template. For example, the user interface may provide textual information about the data structures for each tag such that a user may decide which element or elements of the business data of the business data provider are to be associated with each tag. In one example, the benchmarking scenario tag template for a travel expense benchmarking scenario may include tags for data structures associated with travel types or modes (e.g., flight, car, train, etc), vendors (e.g., airline, hotel operator, rental agency, etc.), cost, duration, etc. The business data provider may determine and identify the tags and provide the relevant information via the user interface to the user. In some instances, a user of the business data provider may simply opt in to the use of the benchmarking scenario tag template.

A user may then extract and/or associate the tags with elements of the business data of the business data provider (block 510). For example, the user may extract or retrieve the relevant elements of business data through a business application (for example, SAP®'s Travel OnDemand solution or any other business application) or other interface for accessing the business data model of the business data provider. In some implementations, a configuration user interface may be provided to select and map each tag to one or more elements of the business data and/or metadata based on the defined data structures for each tag of the benchmarking scenario tag template. In some instances, a user may also provide a selection of whether to anonymize or pseudonymize the tagged elements of business data via a configuration user interface. For example, a user interface feature, such as a radio button, checkbox, pop-up window, or other feature may be provided for the user to indicate whether the one or more tagged elements of the business data is to be anonymized or pseudonymized. In still further instances, a user may also provide a selection of whether to opt-in to permit the extraction of tagged elements of business data for a benchmarking scenario via a user interface. If the user opts-in to the benchmarking scenario, then the tagged element or elements of the business data may be incorporated into the benchmarking data of the benchmarking system server, such as the benchmarking data 216 of the benchmarking system server 212 of FIG. 2, such that the tagged element or elements of business data may be utilized to improve, expand, and/or otherwise augment the data of the benchmarking data of the benchmarking system server. In some instances, the user may save the association of the tags with the business data as a configuration for that particular benchmarking scenario tag template. Accordingly, the configuration may be used when business data is extracted and transferred to the benchmarking system server 212, such as subsequent extractions and transfers.

In some implementations, the system of the business data provider may transform or otherwise modify the tagged elements of business data to preserve the confidentiality of the business data prior to transmission to the benchmarking system server. For example, a determination may be made whether to pseudonymize or anonymize one or more tagged elements of the business data of the business data provider (block 512). As noted above, the tagged elements of business data may be previously designated as pseudonymized and/or anonymized elements of business data. It should be understood that the modification of the tagged elements of business data does not affect the original business data of the business data provider. Rather, an extracted copy of the tagged elements of business data is modified.

If the user elects to pseudonymize the one or more tagged elements of the business data and/or if the one or more tagged elements of the business data was previously selected to be pseudonymized, then a process may be performed to remove and/or replace one or more, or all, of the identifiable information of the tagged elements with an artificial identifier (e.g., a randomly generated number, a randomly generated alphanumeric artificial identifier, a business data provider- or user-defined artificial identifier, and/or other artificial identifier) such that the business data provider, other entities, and/or other information is not identifiable in the pseudonymized data (such as information about suppliers, customers, sales persons, employees, internal organizational structures, relationships, etc.) (block 514). By way of example, the process to pseudonymize the data may include the removal of any string or other non-numerical data from the tagged elements of business data and the association of the artificial identifier with the tagged element of business data. Accordingly, numerical data or otherwise classifying information (e.g., codes or text identifiers) and the artificial identifier may remain for the element of the business data that is associated with the tag. Thus, much, if not all, of the information that may be used to identify the business data provider, other entities, and/or other information may be removed, suppressed, or otherwise obscured. It should be understood that the pseudonymization of the one or more tagged elements of the business data does not affect the original business data of the business data provider, but such modification is performed on extracted business data, such as that received by an ETL adapter or otherwise.

Of course, other methods of pseudonymizing the elements of the business data may be utilized as well. For example, the business data provider may include an array of words, values, and/or other data for which the tagged element of business data may be searched to determine if one or more of the words, values, and/or other data is present in the tagged element of business data. If one or more words, values, and/or other data are present in the tagged element of business data, the words, values, and/or other data may be replaced with the artificial identifier or simply deleted. In some instances, the artificial identifier may only replace the name of the business data provider in the tagged element of business data.

In some implementations, a preview (e.g., one record) of the pseudonymized elements of the business data may be provided to a user to confirm that the pseudonymized elements of the business data has suitably removed any identifiable information except for the artificial identifier and/or other non-identifiable information (e.g., via a pop-up preview window or otherwise). In some implementations, a copy of the artificial identifier may be locally stored (e.g., in a data storage device of the business data provider and/or a client associated with the business data provider) such that the artificial identifier may be identified in the returned benchmarking data containing the artificial identifier. In some instances, the copy of the artificial identifier may be associated with the locally-stored elements of the business data corresponding to the tagged elements of the business data with which the artificial identifier is utilized. In some implementations, several artificial identifiers may be included in the pseudonymized elements of the business data.

If the user elects to anonymize the one or more tagged elements of the business data (block 512), then a process may be performed to remove and/or suppress identifiable information of the tagged elements such that the business data provider, other entities, and/or other information is not identifiable in the anonymized data (e.g., suppliers, customers, sales persons, employees, internal organizational structures, relationships, etc.) (block 514). By way of example, the process to anonymize the data may include the removal of any string or other non-numerical data from the tagged elements of business data. Accordingly, numerical data or otherwise classifying information (e.g., codes or text identifiers) may remain for the element of the business data that is associated with the tag. Thus, much, if not all, of the information that may be used to identify the business data provider, other entities, and/or other information may be removed, suppressed, or otherwise obscured.

Of course, other methods of anonymizing the elements of the business data may be utilized as well. For example, the business data provider may include an array of words, values, and/or other data for which the tagged element of business data may be searched to determine if one or more of the words, values, and/or other data is present in the tagged element of business data. If one or more words, values, and/or other data are present in the tagged element of business data, the words, values, and/or other data may be deleted or a placeholder value may be used (e.g., a 0). In some instances, only the name of the business data provider may be deleted in the tagged element of business data. In some implementations, a preview of the anonymized data may be provided to a user to confirm that the anonymized data has removed the desired identifiable information (e.g., via a pop-up preview window or otherwise).

In some instances, the tagged elements of business data may populate a tagged XML file with the pseudonymized and/or anonymized data. In some implementations, the anonymized and/or pseudonymized data may be stored by the system of the business data provider and/or an ETL adapter and may be transmitted to the benchmarking system server periodically and/or on-demand. Accordingly, in some implementations, the process 500 may end or suspend after the pseudonymization and/or anonymization of the element or elements of business data (represented by the dashed line in FIG. 5).

The transformed elements of business data may be transmitted to the benchmarking system server (block 516). The transformed elements of business data may be transmitted over a network, such as the internet, to the benchmarking system server. In some implementations, the transformed elements of business data may be further secured via encryption or other methods prior to transmission to the benchmarking system server. The transmission of transformed elements of business data may occur periodically, on-demand (by either the benchmarking system server and/or the business data provider), and/or otherwise.

The transformed tagged elements of business data may be received by the benchmarking system server (block 518). In some instances, the transformed tagged elements of the business data may be stored (block 520) with other tagged elements of the benchmarking data in a database, data warehouse, and/or other storage device of the benchmarking system server. In some instances, the storage of the tagged elements of the business data may be performed only if a user of the business data provider elects to opt-in to the benchmarking scenario. If, for example, the transformed element of business data includes sales data for the month of May for the year of 2011 in Germany for a business in the automotive industry, then the sales data may be stored with other received or otherwise acquired sales data for the month of May for the year of 2011 in Germany for businesses in the automotive industry in the database containing the benchmarking data. In some instances, the user may not elect to opt-in and the tagged business data may not be stored and/or may not be transmitted to the benchmarking system server at all. In some implementations, providing benchmarking data may be conditioned on opting-in to a benchmarking scenario and/or may otherwise incentivize users to opt-in to providing tagged business data for the database of benchmarking data.

In some instances, the process 500 may end or suspend after storing the transformed tagged elements of the business data in a database of the benchmarking system server (represented by the dashed line in FIG. 5). For example, the transformed tagged elements of the business data may be extracted from the business data provider and/or via an ETL adapter to the benchmarking system server on a periodic or on-demand basis. In some instances, the extraction of the transformed tagged elements of the business data may occur without a request for benchmarking data such that the business data provider simply provides the transformed tagged elements of the business data to the benchmarking system server.

The benchmarking system server may utilize the received tagged elements of business data with the benchmarking data of the benchmarking system to generate benchmarking data (block 522). For example, the benchmarking system server may determine the benchmarking scenario for the tagged elements of business data based on the benchmarking scenario tag template used and may select the applicable benchmarking data. Utilizing the benchmarking data and the tagged elements of the received business data, the benchmarking system server may generate the resulting benchmarking data. In some implementations, the benchmarking data may include the generation of a report or other document, such as a balanced scorecard and/or process scorecard. In other implementations, simple numerical data may be generated for the benchmarking data. In still other implementations, the benchmarking data may include the generation of numerical performance metrics (e.g., averages, minimums, maximums, etc.), graphical representations of the performance metrics (e.g., pie charts, bar graphs, line graphs, heat maps, color-coded maps, performance dashboard elements, etc.), textual and/or narrative content, and/or other forms for the benchmarking data. In some implementations, the benchmarking data may include the artificial identifier, if applicable, such that the business data provider may identify or otherwise detect the business data of the business or entity to determine a relative position and/or ranking in the benchmarking data. For instance, the relative ranking may include a bar graph comparing the performance of the business or entity relative to the applicable benchmark metric. An example of such a comparison may be between the average cost for flights from Berlin, Germany to New York, N.Y., USA for the business or entity and the aggregate average cost for a flight from Berlin, Germany to New York, N.Y., USA based on the benchmark data of the benchmarking system server for all businesses, comparable businesses, and/or other applicable filters. In some instances, the business data provider may request benchmarking data without extraction of tagged elements of business data.

The generated benchmarking data may be transmitted back to business data provider (block 524). The benchmarking data may be transmitted over a network, such as the internet, to the business data provider. In some implementations, the benchmarking data may be further secured via encryption or other methods prior to transmission to the business data provider. The benchmarking data may be received by the business data provider (block 526) and output for use. In some implementations, the benchmarking data may be visually displayed to the user via a GUI, saved to a data storage device as a file, incorporated into a business application (such as SAP®'s Business Objects BI OnDemand solution or other business applications), and/or otherwise utilized by the user or business data provider.

In instances where the received benchmarking data includes one or more artificial identifiers, the business data provider, a client associated with the business data provider, and/or an application executed by the business data provider and/or client may compare one or more stored artificial identifiers with the one or more artificial identifiers included in the received benchmarking data. If the one or more stored artificial identifiers match one or more of the artificial identifiers included in the received benchmarking data (that is, if the artificial identifier is detected in the received benchmarking data), the corresponding data or results associated with the artificial identifier may be highlighted or otherwise presented. In some implementations, the data associated with the artificial identifier may be graphically and/or textually presented relative to the aggregate benchmarking data.

In some implementations, the process 500, or at least parts of the process 500, may be automated such that benchmarking data may be automatically (e.g., without manual intervention) generated and retrieved periodically. In one implementation, the transformation and/or extraction of tagged elements of business data may be automated. For example, the process 500 may be implemented to retrieve existing, updated, modified, and/or newly created and tagged elements of business data of the business data provider, pseudonymize and/or anonymize the tagged elements of business data, and extract or transmit the transformed elements of business data to the benchmarking system server. In some implementations, a configuration saved by a user when tagging the business data may be used for extraction and transformation of the tagged elements of business data. In a further implementation, the generation of a report including the resulting benchmarking data received from the benchmarking system server may be automated. Such automatically generated benchmarking data may be used by an entity, such as a business, to monitor the various performance metrics on a periodic basis and/or for other uses.

While the foregoing has described a process 500 for tagging elements of business data and generating benchmarking data using pseudonymized and/or anonymized elements of business data, various systems and configurations for implementing the process 500 will now be described.

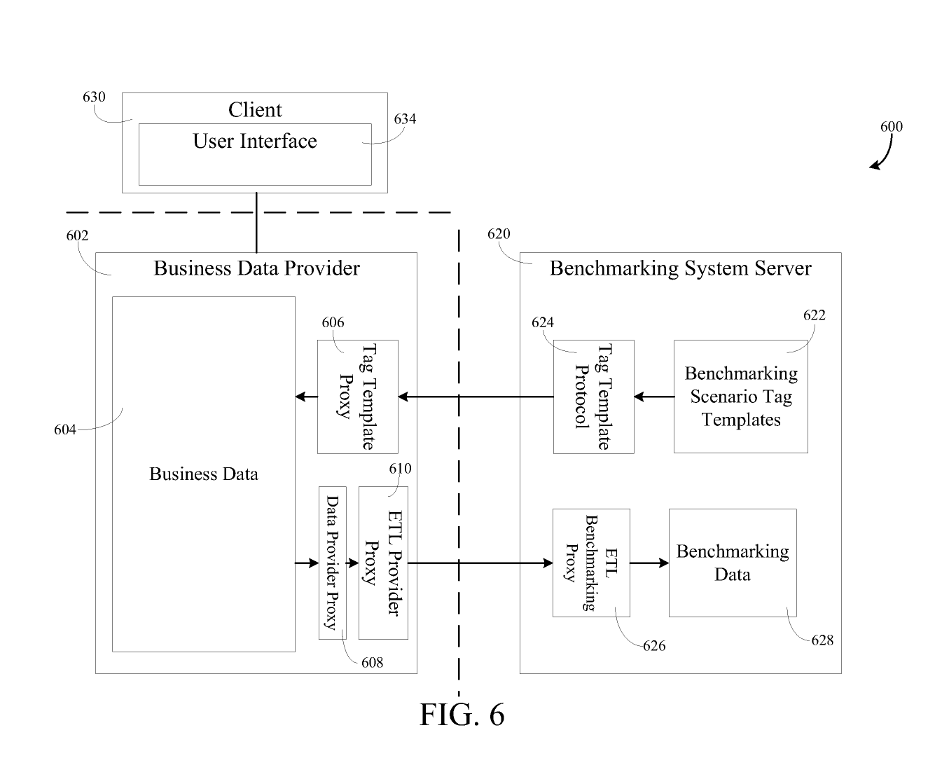

FIG. 6 depicts an example system 600 and interactions between a business data provider 602, the benchmarking server 620, and a client 630. In one implementation, the client 630 may include a user interface 634 and may access and/or otherwise interact with the business data provider 602, either locally or remotely (via a wired and/or wireless network) to allow a user to configure and administer the business data provider 602. The user interface 634 may be configured in accordance with the user interface 204 described above and/or otherwise.

The business data provider 602 may include a computing device, such as a server, or several computing devices, such as several servers. In some implementations, the business data provider 602 may include an application, such as a business application (e.g., SAP®'s Travel OnDemand solution), a business intelligence application, and/or a database management applications (e.g., SAP®'s HANA solution). The business data provider 602 of the present example includes business data 604, a tag template proxy 606, a data provider proxy 608, and an ETL provider proxy 610. In some implementations, the data provider proxy 608 and the ETL provider proxy 610 may be a single proxy. In other instances, the tag template proxy 606, data provider proxy 608, and/or ETL provider proxy 610 may be integrated into the business data provider 602 and/or omitted.

The business data 604 may be stored in a database, a data warehouse, and/or other data storage device. The business data 604 may include several elements of business data that may be extracted, transformed, and delivered to the benchmarking system server 620 in accordance with process 500. The tag template proxy 606 may be an application or service configured to retrieve new, existing, and/or updated benchmarking scenario tag templates 622 from the benchmarking system server 620. For instance, a user may utilize the user interface 634 of client 630 to interact with the business data provider 602 to cause the tag template proxy 606 to request and/or receive benchmarking scenario tag templates 622 from the benchmarking system server 620 via a tag template protocol 624. In one implementation, the tag template proxy 606 of the business data provider 602 may establish a connection over, for example, TCP/IP with the benchmarking system server 620. The tag template proxy 606 may authenticate itself and the business data provider 602 with the benchmarking system server 620. Upon successful authentication, the benchmarking system server 620 may transmit new and/or update benchmarking scenario tag templates 622.

The data provider proxy 608 may be configured to interact with the business data 604 stored in a database, data warehouse, and/or other data storage device and to extract elements of business data 604 based on the associated tags. For example, the data provider proxy may be an application or service that is configured to determine which elements of business data 604 are associated with the tags for a specific benchmarking scenario tag template 622, extract the relevant elements of the business data 604, and/or transform the extracted elements of the business data 604 based on a pseudonymization or anonymization selection. In some implementations, a user may utilize the user interface 634 of client 630 to interact with the business data provider 602 to cause the data provider proxy 608 to extract and transform the relevant elements of the business data 604 based on a selected benchmarking scenario tag template 622. In one implementation, the data provider proxy 608 may construct and SQL query based on the elements of the business data 604 associated and/or otherwise identified for the tags of the benchmarking scenario tag templates 622. The data provider proxy 608 may then execute the SQL query on the database, data warehouse, and/or other data storage device storing the business data 604. The data provider proxy 608 may transform the responsive elements of the business data 604 based on the settings defined by the benchmarking scenario tag template 622 and/or via a user interface 634. Once the extracted business data 604 has been transformed, the data provider proxy 608 may send the transformed business data 604 to the ETL provider proxy 610.

The ETL provider proxy 610 may be an application or service configured to communicate with the benchmarking system server 620 to send transformed tagged elements of extracted business data 604 to the benchmarking system server 620. In some instances, the ETL provider proxy 610 may receive transformed tagged elements of business data 604 from the data provider proxy 608 to the benchmarking system server 620. In some implementations, the ETL provider proxy 610 may encrypt and/or otherwise secure the transformed elements of the business data 604 of the business data provider 602. In still further implementations, the ETL provider proxy 610 may further transform the tagged elements of the business data 604 as an ETL provider for use by the benchmarking system server 620 as an ETL consumer. In some implementations, the ETL provider proxy 610 may establish a connection, for example over TCP/IP, with the benchmarking system server 620 upon receiving the transformed tagged elements of the business data 604 from the data provider proxy 608. The ETL provider proxy 610 may then authenticate the business data provider 602 with the benchmarking system server 620. Upon successful authentication, the ETL provider proxy 610 may send the transformed tagged elements of the business data 604 to the benchmarking system server 620. Once the data has been transmitted, the ETL provider proxy 610 may close the connection. In another implementation, the benchmarking system server 620 may establish a connection, for example over TCP/IP, with the business data provider 602, periodically, on-demand, and/or otherwise. The ETL provider proxy 610 may authenticate the benchmarking system server 620 with the business data provider 602. Upon successful authentication, the ETL provider proxy 610 may send the transformed tagged elements of the business data 604 to the benchmarking system server 620. Once the data has been transmitted, the ETL provider proxy 610 and/or the benchmarking system server 620 may close the connection.

The benchmarking system server 620 may include benchmarking scenario tag templates 622, a tag template protocol 624, an ETL benchmarking proxy 626, and benchmarking data 628. In some implementations, the benchmarking system server 620 may have one or more components associated with one or more computing devices (such as, for example, to implement parallel processing of data and/or otherwise). The benchmarking scenario tag templates 622 are defined tag templates for various benchmarking scenarios. One method for defining and/or saving benchmarking scenario tag templates 622 is discussed above in reference to the method 300 of FIG. 3. In one implementation the benchmarking scenario tag templates 622 may be stored in a database, data warehouse, and/or other data storage device of the benchmarking system server 620. Additional implementations may store the benchmarking scenario tag templates 622 in other manners, for example as an XML file on a file system or otherwise.

The tag template protocol 624 may be an interface configured to enable communication between the business data provider 602's system and the benchmarking system server 620. In the present example, the tag template protocol 624 is configured to receive requests for benchmarking scenario tag templates 622 and transmit the requested benchmark scenario tag templates 622 to the business data provider 602.

The ETL benchmarking proxy 626 may be an application or service configured to communicate with the business data provider 602 to receive transformed tagged elements of the business data 604 from the business data provider 602. In some instances, the ETL benchmarking proxy 626 may receive transformed tagged elements of the business data 604 from the ETL provider proxy 610 of the business data provider 602. In some implementations, the ETL benchmarking proxy 626 may decrypt the transformed tagged elements of the business data 604 of the business data provider 602 for use and analysis by the benchmarking system server 620. In still further implementations, the ETL benchmarking proxy 626 may transform the transformed tagged elements of the business data 604 for use by the benchmarking system server 620 as an ETL consumer.

The benchmarking data 628 consists of data from several business data providers 602, wherein the data has been transformed and/or tagged based on the benchmarking scenario tag templates 622 retrieved by the business data providers 602. The stored benchmarking data 628 may be associated with various tags utilized by the benchmarking scenario tag templates 622 of the benchmarking system server 620 and may be stored in a database, data warehouse, and/or other data storage device. The benchmarking data 628 may be updated and/or added to periodically, such as by the benchmarking system server 620 and/or the business data provider 602, or when benchmarking data is requested by a business data provider 602. In some implementations, the received tagged elements of the business data 604 from a business data provider 602 may be anonymized prior to being added and/or updated in the database, data warehouse, and/or other data storage device for the benchmarking data 628. The benchmarking system server 620 may provide results from the benchmarking to the business data provider 602.

A user using a client 630 may access the business data provider 602 using the user interface 634, which may be similar to the user interface 202 of FIG. 2 discussed above. In one implementation, the user may define relationships between the tagged elements of the business data 604 and tags of the benchmarking scenario tag templates 622 received and/or selected for use by the business data provider 602. For example, based on the requirements set in the benchmarking scenario tag template 622, the user may associate various elements of the business data 604 with the required tags and determine whether each element should be pseudonymized or anonymized. The user may also associate various elements of the business data 604 with any optional tags of the benchmarking scenario tag template 622. The user may save, execute, or otherwise implement the settings by clicking on a button presented by the user interface 634, for example.

In another example implementation, a user may be presented with a user interface 634 with options for selecting a business scenario tag template by clicking on a link. Upon selecting a business scenario tag template, the user may be presented with business data 604 elements that are available on the business data provider 602. The user may then establish relationships between a tag of the benchmarking scenario tag template 622 and one or more elements of business data 604 by, for example, associating the appropriate combination of the element and the tag in one or more drop down lists. In some implementations, the tag may include metadata that may be appended, prepended, and/or otherwise inserted into the metadata of the selected element of the business data 604.

The user may also be presented with additional options based on the tag selected and the configuration options available for the applicable benchmarking scenario tag template 622. For example, the benchmarking scenario tag template 622 may contain a tag, such as “Sales by Month,” and an option to anonymize or pseudonymize the selected elements of the business data 604. The user interface 634 may present a checkbox or other user interface feature to allow the user to indicate that the element of the business data 604 is to be anonymized or pseudonymized by checking the checkbox and/or otherwise interacting with the user interface feature. In some implementations, a user may adjust multiple settings via the user interface 634 and may accept the settings by clicking on a “submit” button.

Of course, other components for client 630, benchmarking system server 620, and/or business data provider 602 may be included and/or otherwise implemented.

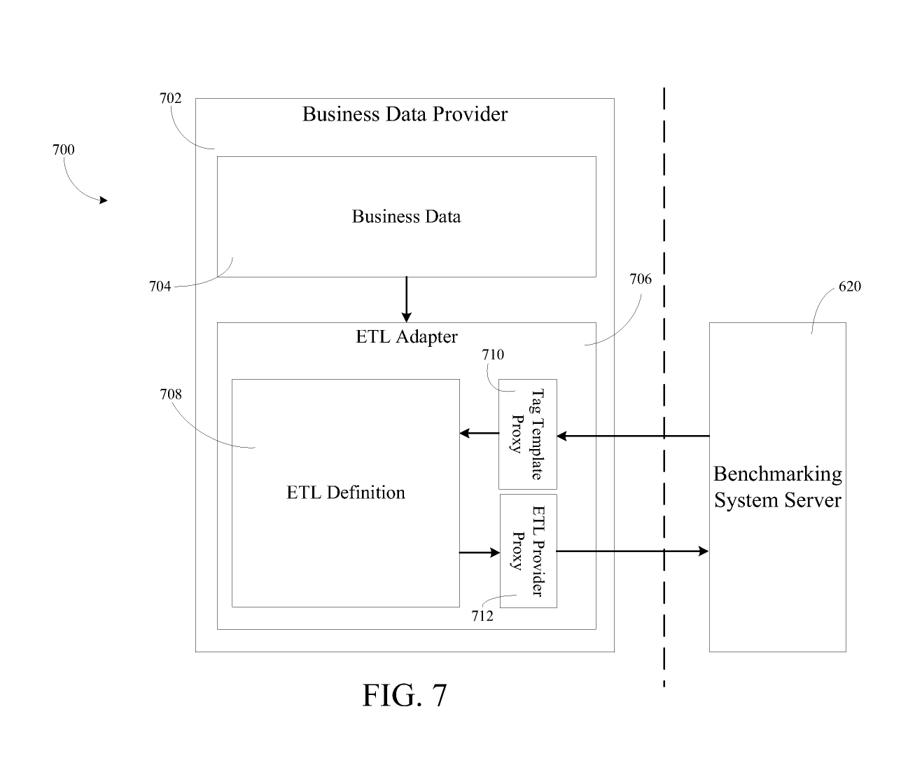

FIG. 7 depicts another example of a business data provider 702 that may communicate with the benchmarking system server 620 of FIG. 6. Business data provider 702 of this example includes an ETL adapter 706 that may act as an interface with the business data provider 702's system and business data 704, which may be stored in a database, data warehouse, and/or other data storage device. In this way, for example, the extraction, transformation, and loading (ETL) protocols of the business data provider 702's system may be utilized with the ETL adapter 706 without substantial modifications or any modification. In the present example, the ETL adapter 706 includes a tag template proxy 710, an ETL definition 708, and an ETL provider proxy 712. The ETL adapter 706 may receive benchmarking scenario tag templates by establishing a connection using a proxy, such as via the tag template proxy 710. In an example instance, the ETL adapter 706 may periodically establish a connection, using the tag template proxy 710, to retrieve existing, new, and/or updated benchmarking scenario tag templates. The tag template proxy 710 may be configured in a similar manner to the tag template proxy 606 of FIG. 6 and/or otherwise.

The ETL definition 708 of the ETL adapter 706 may provide an interface for the received benchmarking scenario tag template. For example, the ETL definition 708 may provide an interface that may be presented on a user interface for the user to determine which tags are to be associated with various elements of the business data 704 and/or to select whether to anonymize and/or pseudonymize the elements of the business data 704. In some instances, the ETL definition 708 may be used to transform or otherwise provide an interface for the relevant tags of the benchmarking scenario tag template for use with the business data 704 of the business data provider 702's system. The ETL definition 708 may also be used to transform or otherwise provide an interface for the received elements of business data 704 of the business data provider 702 for use by the benchmarking system server 620. The ETL definition 708 may be further used to transform or otherwise provide an interface for the received benchmarking data and/or a report from the benchmarking system server 620 with the business data provider 702's system.

The ETL adapter 706 may be configured to send the extracted tagged elements of the business data 704 to the benchmarking system server 620 by establishing a connection using a second proxy, such as an ETL provider proxy 712. The ETL provider proxy 712 may be configured in a similar manner to the ETL provider proxy 610 of FIG. 6 and/or otherwise.

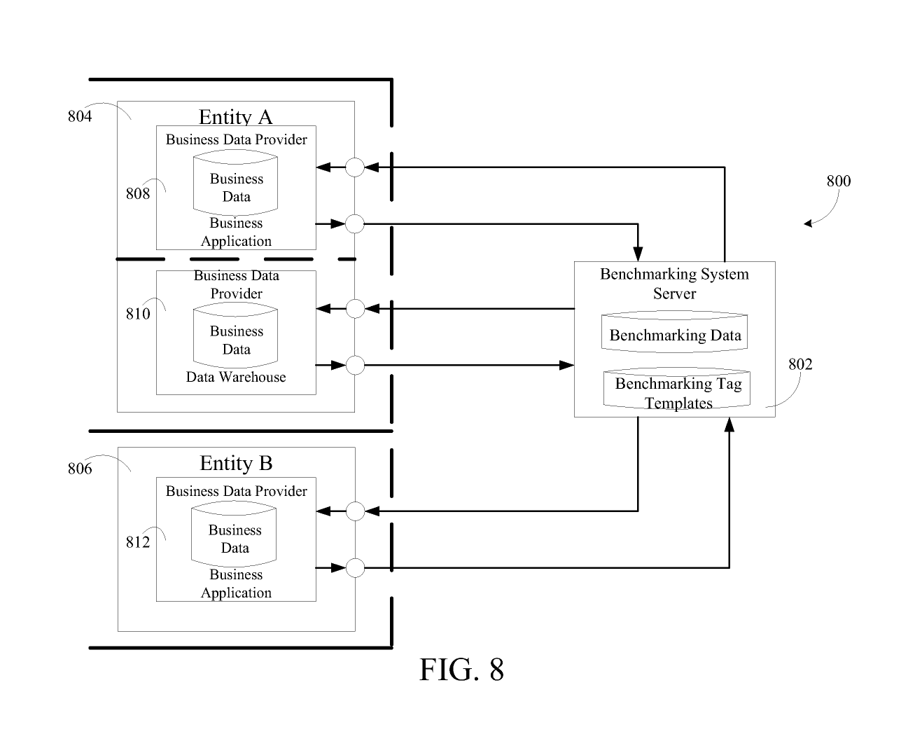

In some implementations, an entity may include several business data provider systems and/or several different entities may interact with the benchmarking system server. For example, FIG. 8 depicts an example system 800 having a benchmarking system server 802 that may interact with a plurality of entities and may receive data from multiple business data providers of each entity. In the example shown, the benchmarking system server 802 is shown interacting with two entities 804 and 806. The entities 804 and 806 may be different businesses, for example. In the example system 800 shown, entity A 804 includes a first business data provider 808 and a second business data provider 810. The first business data provider 808 may independently interact with the benchmarking system server 802 and the second business data provider 810 may, also, independently interact with the benchmarking system server 802. In the example system 800, the first business data provider 808 and the second business data provider 810 may not reside in the same location and or may not be otherwise associated other than being associated with the same entity 804. For example, business data provider 808 may be a business application having a first set of business data, and business data provider 810 may be data warehouse having a second set of business data, such as aggregate business data. Of course, the foregoing are merely examples and other business data providers may be used.

In the present example, each business data provider 808 and 810 of entity 804 may provide tagged elements of business data to the benchmarking system server to populate the benchmarking data database and/or may receive benchmarking data and/or reports based on the benchmarking data and the provided tagged elements of the business data for each business data provider 808, 810. Accordingly, it may be appreciated that an entity having several different business data providers may utilize the benchmarking system server 802 to receive benchmarking data even if the business data providers of the entity are different. Moreover, for very large entities, benchmarking data and/or reports may be generated for different divisions, corporations, entities, etc., without having to provide an internal benchmarking system.

In addition to the advantages that the benchmarking system server 802 may provide to a single entity having several different data provider systems, the example system 800 also depicts a second entity, entity B 806, that may benefit from the benchmarking system server 802. In the example shown, entity B 806 has a single business data provider 812. The business data provider 812 may also be configured to communicate with the benchmarking system server 802, but business data provider 812 may not have access to the private business data associated with the business data providers 808 and 810 belonging to entity A 804. However, if the business data providers 808 and 810 provide business data (in an anonymized or pseudonymized manner) to the benchmarking system server 802, the entity 806 may benefit by utilizing the benchmarking data of the benchmarking system server 802, which may include anonymized business data of business data providers 808 and 810. Thus, both entities 804 and 806 may be able to benefit from benchmarking data of the benchmarking system server 802 without having access and/or identifying to the confidential information of the other entity.

Accordingly, it may be appreciated that a system 800 having tens, hundreds, thousands, and/or millions of business data providers providing tagged elements of business data to populate benchmarking data of a benchmarking system server 802 may be beneficial to each entity and/or business data provider while maintaining confidentiality of the tagged elements of business data through anonymization and/or pseudonymization. In addition, the pseudonymization may be useful for permitting a business data provider to determine a relative position and/or ranking of its tagged elements of business data relative to the benchmarking data of the benchmarking system server 802.

Of course, other implementations and/or uses of the benchmarking system servers, benchmarking scenario tag templates, and/or other components may be possible.

The foregoing methods and/or systems may be implemented by one or more computer programs (e.g., programs, software, software applications or code), including machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor. A “machine-readable medium” and “computer-readable medium” do not include transitory signals.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method comprising:
receiving, at one or more processing modules, a benchmarking scenario tag template;
determining, using the one or more processing modules, a tag of the benchmarking scenario tag template;
associating, using the one or more processing modules, the tag with one or more elements of the business data to result in one or more tagged elements of the business data;
receiving a selection to pseudonymize or anonymize the one or more tagged elements of the business data;
extracting the one or more tagged elements of business; and
transforming, using the one or more processing modules, the one or more tagged elements of the business data based on the received selection.

2. The method of claim 1, wherein the benchmarking scenario tag template defines the data structures of the business data with which the tag is to be associated.

3. The method of claim 1, wherein the received selection is a pseudonymize selection, wherein the step of transforming the one or more tagged elements of the business data based on the received pseudonymized selection comprises replacing one or more identifiable portions of the one or more tagged elements of business data with an artificial identifier.

4. The method of claim 3, further comprising receiving benchmarking data including the artificial identifier.

5. The method of claim 3, wherein the artificial identifier is a generated random number.

6. The method of claim 3, wherein the artificial identifier is a user-defined artificial identifier.

7. The method of claim 1, wherein the received selection is an anonymize selection, wherein the step of transforming the one or more tagged elements of the business data based on the received anonymized selection comprises removing one or more identifiable portions of the tagged elements of the business data.

8. The method of claim 1, further comprising receiving benchmarking data, wherein the benchmarking data is generated based on data from a plurality of business data providers and the transformed one or more tagged elements of the business data.

9. A system comprising:
a tangible computer-readable storage device comprising instructions; and
one or more data processors coupled to the tangible computer-readable storage device and configured to execute the instructions to perform operations comprising:
transmitting a benchmarking scenario tag template having a tag associated with one or more data structures;
receiving an element of business data associated with the tag, wherein the element of the business data comprises a pseudonymized or anonymized element of the business data;
generating benchmarking data based on the received pseudonymized or anonymized element of the business data associated with the tag and benchmarking data associated with the tag from a database; and
transmitting the generated benchmarking data to a business data provider.

10. The system of claim 9, wherein the received element of the business data is a pseudonymized element of the business data, wherein the pseudonymized element of the business data comprises an artificial identifier.

11. The system of claim 10, wherein the artificial identifier is a generated random number.

12. The system of claim 10, wherein the artificial identifier is a business data provider-defined artificial identifier.

13. The system of claim 9, wherein the received element of the business data is an anonymized element of the business data, wherein the anonymized element of business data does not contain identifiable information associated with the business data provider.

14. The system of claim 9, wherein the one or more data processors are further configured to execute the instructions to perform the operations comprising:
receiving a benchmarking scenario opt-in selection; and
storing the pseudonymized or anonymized element of the business data associated with the tag in the database.

15. The system of claim 14, wherein the operation of transmitting the generated benchmarking data to a business data provider is performed only if the benchmarking scenario opt-in selection is received.

16. The system of claim 9, wherein the one or more data structures associated with the tag of the benchmarking scenario tag template are technology independent.

17. A system for supporting benchmarking services comprising:
a business data provider having a module, wherein the module is configured to:
receive a first benchmarking scenario tag template,
identify a first set of elements of business data based on the first benchmarking scenario tag template,
extract the identified first set of elements of business data,
pseudonymize or anonymize an element of the extracted first set of elements of business data, and
transmit the extracted first set of elements of business data to a remote system.

18. The system of claim 17, wherein the extraction, pseudonymization or anonymization, and/or transmission occurs without manual intervention.

19. The system of claim 17, wherein the module is configured to:
receive a second benchmarking scenario tag template,
identify a second set of elements of business data based on the second benchmarking scenario tag template,
extract the identified second set of elements of business data,
pseudonymize or anonymize an element of the extracted second set of elements of business data, and
transmit the extracted second set of elements of business data to the remote system.

20. The system of claim 17, wherein the benchmarking scenario tag template is not a file to be populated by the business data provider.
